(19) United States
(12) Patent Application Publication
(10) Pub. No.: US 2011/0310386 A1
(43) Pub. Date: Dec. 22, 2011

(54) METHOD AND SYSTEM FOR ANALYSING SOLID PARTICLES IN A MEDIUM

(75) Inventors: Jean-Baptiste Renard, Orleans (FR); Bertrand Gaubicher, Orleans (FR); Jean-Luc Mineau, Cergy (FR)

(73) Assignees: ENVIRONNEMENT S.A., POISSY (FR); CENTRE NATIONAL DE LA RECHERCHE SCIENTIFIQUE- CNRS, PARIS CEDEX 16 (FR); UNIVERSITE D'ORLEANS, Orleans (FR)

(21) Appl. No.: 13/129,960

(22) PCT Filed: Nov. 17, 2009
(86) PCT No.: PCT/FR2009/001321

§ 371 Date: Sep. 8, 2011

(30) Foreign Application Priority Data
Nov. 18, 2008 (FR) 08/06447

(51) Int. Cl. G01N 21/47

(52) U.S. Cl. 356/340

(57) ABSTRACT

A system (1) for analyzing solid particles in a medium (2), includes illumination elements (3) capable of generating a light field (30) in the medium (2), elements (4) for trapping at least a portion (30′) of the light field (30) generated and arranged in the direction (31) of the light field, and main detection element (5) for detecting the light field (30″) diffused by the solid particles within the medium (2). The main detection element includes a photodetector (52) for the light field (30″) diffused by the solid particles in the medium and a counter (53) for counting these solid particles in this medium, this main detection element being positioned in a direction (51) forming an angle (α) substantially ranging between 10° and 20° with respect to the direction of the light field generated. A method for analyzing solid particles in a medium implementing such an analysis system is described.

### TECHNICAL FIELD

The present invention relates to the field of detection and measurement of the amount of solid particles (concentration, size distribution, total mass, nature, etc.) in the atmosphere. It particularly applies for the continuous measurement of aerosols in order to improve the quality of air, for example ambient air, industrial waste or engine gas.

More particularly, it relates to a system for analyzing solid particles in a medium, comprising illumination means capable of generating a light field within the medium, trapping means for trapping at least a portion of the light field generated and arranged in the direction of this light field, and main detection means for detecting the light field diffused by these solid particles in this medium.

It also relates to a method for analyzing solid particles in a medium, comprising an illumination step for generating a light field in the medium, a trapping step for trapping at least a portion of the light field generated and arranged in the direction of this light beam and a step for detecting the light field diffused by these solid particles in this medium.

### PRIOR ART

The impact of particles on public health requires implementation of high-precision instruments for detecting and measuring solid particles in the atmosphere which can detect particles of any nature, including the darkest particles such as soot as well as small sized particles, whose size is typically less than a few micrometers.

A first technique for measuring solid particles in the atmosphere consists in a manual gravimetric measurement by sampling particles with a filter then weighing the filtered particles. This technique, considered as the reference from a legal standpoint, is inappropriate for real time onsite monitoring operations due to the necessity of manual processing.

A second known technique consists in using an oscillating microbalance device in order to obtain an automatic measurement adapted to the onsite monitoring operations. The drawback of such measurement is that it is dependent on ambient conditions, particularly humidity as well as the particle composition in the case where volatile components are present. To compensate for this dependence, empirical corrections are carried out by adding a posteriori determined coefficients, which proves to be restrictive and hardly reliable.

A third known technique consists in the absorption of a beta radiation. This solution called “Beta gauge”, involves the use of a radioactive source and also proves to be unusable in real time. In fact, depending on the concentration of solid particles, a measurement result may be obtained each hour at best. In addition, the detection minimum of this technique deteriorates in the case of small dimension particles.

In order to improve the measurement precision and to avoid destroying the sample, solutions for using non intrusive optical measures have been developed for determining the particle concentration of the medium as well as the distribution per size range. These techniques are sensitive to high time variations of aerosol concentration and may enable the detection of very small concentrations.

These solutions mainly consist in taking a sample of and conveying aerosol-shaped, solid particles into a duct. A laser radiation emitting device radiates these solid particles, thus leading to the diffusion of this radiation. A detection device is arranged facing the emitting device such as to collect a portion of the diffused light. This collected diffused light makes it possible to achieve a quantitative measurement of the number of particles (count) which is then converted into a mass concentration as well as to have a size range ranking.

Several optical measurement means are known. A first means is a photometer for instantaneously measuring the flux variations relating to the concentration variations of solid particles. Thus, it is possible to derive from the photometry measurements the concentration variation of solid particles per time unit. A second means is an aerosol counter for analyzing the presence of particles by a pulse detector. This technique enables assessment of the particle concentration between a minimum size threshold and a maximum size threshold. It can also measure the size of the particles through the intensity of the detected light flux. It is also possible to combine these two means to obtain hybrid results.

A solution based on an optical measurement is described in US patent document 2003/0054566. In this document, an aerosol containing solid particles is introduced into a measurement cell. A laser beam crosses an inlet window to the inside of the measurement cell and intercepts the aerosol flux. The laser beam is diffracted on the particles of the aerosol, the latter constituting an obstacle to light. The diffused light which is generated by diffracting the laser beam then crosses an outlet window, and is then focused by means of a lens towards a detector. Thus, a measurement of the light diffused by the particles is obtained.

However, this solution has a major drawback. The collection of the light diffused by the solid particles does not make it possible to obtain an acceptable measurement precision. Thus, the results provided by this technique are not precise, particularly with the presence of dark particles of small dimensions such as soot.

Another solution is described in the patent document CA 2 017 031. In this document, a light source generates a light beam in the direction of the medium to be analyzed. A diffused light collector further comprises a transparent and fluorescent material. Photoreceptors are arranged such as to be optically coupled to some areas of the collector from where the diffused light may exit.

The drawback of this solution resides in the position of the detectors and the implementation complexity. This detector arrangement does not always provide a sufficient quantity of diffused light for obtaining a high precision with respect to the measurement results, particularly with regard to dark and/or absorbent particles and small sized particles.

Another solution is described in U.S. Pat. No. 5,043,591. In this document, a system for analyzing particles comprises a first scattering chamber, means for providing a fluid sample shaped as a laminar flow in the first scattering chamber, as well as a light beam—for example generated by a laser—arranged to intercept the sample at right angles with respect to the direction of the flow of the sample at a focal point of a first concave mirror. This first concave mirror is used to direct the light diffused by the individual particles in the sample towards at least a light collector. The system also comprises means for converting the collected light into electric signals with for the analysis and processing thereof, as well as means to trap the non diffused light. Thus, it is possible to collect a more important flux of diffused light, thus improving the precision of the measurements of light diffused by the particles.

Still in this document, it is also provided to perform an opening in the first concave mirror in order to lead to a second scattering chamber comprising a second concave mirror and a light collector arranged at its closest focal point and positioned such that its distant focal point is at the interception point of the light beam and the sample. The purpose of this second scattering chamber is to make it possible to detect and analyze the light diffused at small angles by individual particles. This portion of the light beam in fact provides data with a view to determining the dimensions of the particles.

Thus, this solution makes it possible both to count, in real time, the individual particles in a sample in order to distinguish different shapes of particles—spherical or non spherical—and to count them separately, as well as to classify the particles by size categories.

However, the drawback of this solution is that it is expensive and its implementation is complex. In fact, the scattering chambers, the collimation optics and the concave mirrors, while providing more diffused light towards the collectors, prove to be relatively expensive and difficult to assemble.

Moreover, with the known optical measurement techniques, very different situations related to the size and nature of the particles may lead to similar light fluxes at certain scattering angles, thus making these techniques hardly reliable for the identification of the nature of the particles.

Thus, no solution of the related art makes it possible to carry out a precise, real time counting in order to determine the concentration of particles of small dimensions and a photometric measurement so as to assess the size of the particles and their different natures, particularly in the case of dark and/or small sized particles, while being simple to implement and inexpensive.

### OBJECT OF THE INVENTION

The object of the present invention is to remedy to these technical complexities; to this end, it provides a detection means which is simple to achieve and implement, comprising counting and photometry elements, so as to be oriented in a direction forming an angle lower than 30° with respect to the direction of the light field generated by the light means. The measurement of the intensity of the light diffused at these angles makes it possible to assess the number of particles per size range almost independently from their nature.

The approach of the solution was to study the behavior of the light with respect to transparent or absorbent particles, of different optical indexes, and of diameters ranging between 0.3 and 30 micrometers, and to validate and then calibrate the concept by means of real particles of different natures. Thus, surprisingly, it turned out that the detection exhibits a higher level for scattering angles substantially lower than 20°.

To this end, the object of the invention is a system for analyzing solid particles in a medium, comprising a light means capable of generating a light field within the medium, trapping means for trapping at least a portion of the light field generated and arranged in the direction of this light field, and main detection means for detecting the light field diffused by the solid particles in the medium. In this system, the main detection means comprises a photodetector of the light field diffused by the solid particles in the medium and a counter for counting these solid particles in this medium, this main detection means being oriented in a direction forming an angle that is substantially lower than 30° with respect to the direction of said generated light field.

This solution makes it possible to simply achieve a precise system for the real-time analysis of solid particles, without using means for collecting the light diffused by the particles, such as for example a lens or a concave mirror which would have increased the encumbrance of the system and made its implementation more complex. To this end, the invention uses a scattering angle for obtaining a better detection of dark and small sized particles. This detection angle minimizes the influence of the particle refraction index on the measured flux, the measurement thus only being sensitive to the grain size.

Indeed, for an angle lower than 30°, the fact that the particles are absorbent or non absorbent hardly influences the quantity of diffused light. This quantity is dominated by the diameter of the particle and not by its albedo, i.e., the fact that it is light or dark. For higher scattering angles, the diffused light mainly depends on the absorption power of the particles, becoming smaller the more absorbent the particle is. Thus, the instruments conventionally carrying out measurements between 60° and 180° easily detect light and/or transparent particles, but detect large-sized particles only when they are dark.

Preferably, the main detection means is oriented in a direction forming an angle substantially between 10° and 20° with respect to the direction of the light field. Measurements at a scattering angle of 10° are actually not optimal due to contamination by the light source.

Preferably, the main detection means is oriented in a direction forming an angle substantially equal to 15° with respect to the direction of the light field, making it possible to achieve an optimal counting of the solid particles.

According to a preferred embodiment of the invention, the analyzing system also comprises at least a complementary means for detecting the light field diffused by the solid particles in the medium, this complementary detection means comprising a photodetector for detecting the light field diffused by the solid particles in the medium and a counter for counting these solid particles in this medium. Thus, by using several detection means arranged at different angles, namely a main means between 0° and 30° and at least a complementary means between 40° and 140°, measurements are simultaneously obtained at scattering angles in order to assess the nature of the majority particles in the analyzed atmosphere, compared to laboratory-based reference experimental measurements.

In fact, a measurement at a second scattering angle substantially ranging between 40° and 140° makes the scattered flux very dependent on the index, thus making it possible to more particularly assess the nature of the particles.

Preferably, at least a complementary detection means is oriented in a direction forming an angle substantially ranging between 40° and 140° with respect to the direction of the light field.

In this last case, this complementary detection means is preferably oriented in a direction forming an angle substantially equal to 100° with respect to the direction of the light field.

Preferably, at least a complementary detection means is oriented in a direction forming an angle substantially equal to 60° with respect to the direction of the light field.

According to a preferred alternative embodiment of the invention, the analyzing system also comprises at least a complementary detection means for detecting the light field diffused by the solid particles in the medium, this complementary detection means comprising a photodetector for detecting the light field diffused by the solid particles in the medium and a counter for counting such solid particles in this medium, and being oriented in a direction forming an angle substantially equal to 160° with respect to the direction of the light field.

The system according to the invention, accordingly constituted of several detection means arranged at judiciously chosen angles, makes it possible to simultaneously access different information relating to the particles. Indeed, in addition to the particle concentration provided by the detection means between 0° and 20°, it is possible to distinguish the dry solid particles from hydrated ones and from those in a liquid form only.

In a particular alternative embodiment of the invention, at least one counter comprises a bloc for processing the signal generated by the corresponding detection means.

In this last case, preferably, a pulse signal generated by the detection means is rejected by the corresponding signal processing block if the length thereof does not exceed a threshold value depending on the speed of the solid particles in the medium, in order to eliminate false detections due to electronic noise.

The photodetector and the counter are combined to obtain complementary information about the solid particles. The photodetector makes it possible to classify the particles by size categories, whereas the counter makes it possible to count the solid particles by detecting the optical pulses received so as to provide the total particle concentration per unitary volume, as well as the concentration per unitary volume for particles per size range.

According to a particular alternative embodiment of the invention, the analyzing system also comprises a polarimetric analysis means for analyzing the diffused light field. By so combining a counting and photometry detection means with a polarimetric analysis means, a set of complementary information allowing the improvement of the precision of the provided results, particularly with regard to the particle nature, is obtained.

In a particular embodiment, the light means comprises a light source composed of a laser diode.

In another particular embodiment, the light means comprises a diaphragm for selecting a portion of the light field, making it possible to select a portion of the light beam, for example the shiniest or the most homogenous portion.

In another particular embodiment, the trapping means comprises an optical gun and a light trap. This trapping means, located in the direction of the light field generated by the light means, makes it possible to avoid the non diffused light from highly interfering with the measurements carried out by the detection means. The optical gun makes it possible to guide the non diffused light to the light trap so that it may reach the detection means.

In a particular alternative embodiment of the invention, the analyzing system comprises a scattering chamber including a solid particle sample and arranged such as to intercept at least a portion of the light field generated by the light means. With this chamber it is possible to hold a sample of particles to be analyzed, the light, trapping and detection means being arranged at the apertures provided in the chamber.

Advantageously, the analyzing system also comprises means for driving the sample of solid particles suitable for driving the sample along the scattering chamber at a predetermined speed. These means make it possible to monitor the speed of the solid particles in the chamber and hence to know the flow rate of the medium to be analyzed.

Advantageously, the analyzing system also comprises means for filtering the solid particles, arranged at the entry of the scattering chamber such as to select these solid particles depending on their dimensions. Thus, a size range of particles to be analyzed may be filtered. To this end, several filtering heads are available to choose the appropriate range.

Preferably, the analyzing system according to the invention does not contain any means for collecting and focusing light diffused by the particles.

The invention also relates to a method for analyzing solid particles in a medium, comprising a radiation step of generating a light field within the medium, a trapping step for trapping at least a portion of the light field generated and arranged in the direction of this light beam, and a detection step of detecting the light field diffused by such solid particles in this medium. In this analysis method, the step of detecting the diffused light field is a step for carrying out a photodetection of the light field diffused by the solid particles in the medium and counting such solid particles in this medium, this detection step being achieved in a direction forming an angle substantially lower than 30° with respect to the direction of the generated light field.

### BRIEF DESCRIPTION OF THE DRAWINGS

The invention will be better understood upon reading the detailed description of a non limitative exemplary embodiment, accompanied by figures respectively representing:

FIG. 1, a schematic view of a system for analyzing solid particles in a medium according to a first embodiment of the invention,

FIG. 2, views of a system for analyzing solid particles in a medium according to the particular embodiment of the invention,

FIG. 3, a schematic view of a system for analyzing solid particles in a medium according to a second embodiment of the invention, and

FIG. 4, a schematic view of a counter of an analyzing system according to a particular embodiment of the invention.

### DETAILED DESCRIPTION OF PARTICULAR EMBODIMENTS

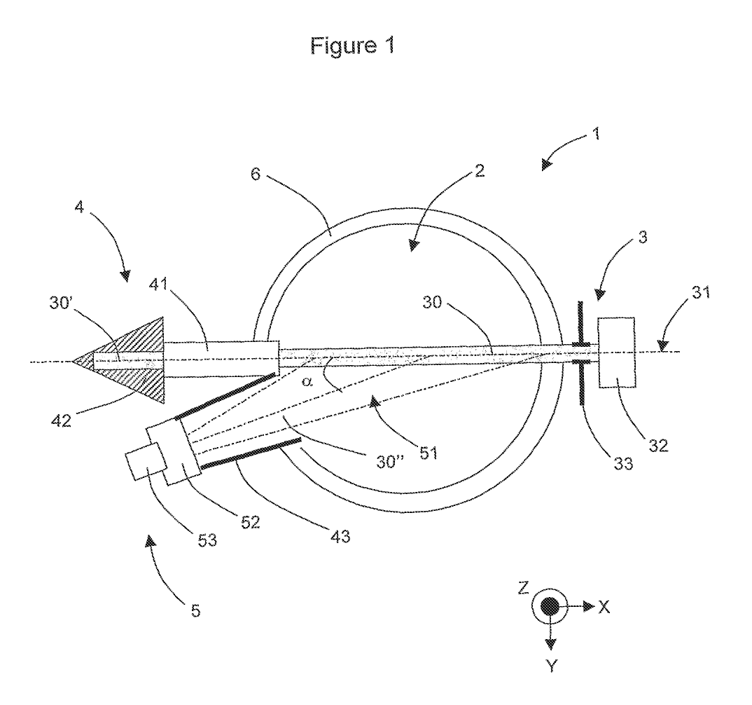

With reference to FIG. 1, a system 1 for analyzing solid particles in a medium 2, according to a first embodiment of the invention, comprises an illumination means 3, a light trapping means 4, a solid particle detection means 5 and scattering chamber 6. With this system it is possible to obtain the granulometry of aerosols, i.e., the particle concentration per size range depending on their diameter.

The illumination means 3 comprises a light source 31 and a diaphragm 32. It is arranged such that the light field that it generates is intercepted by the solid particles moving in the scattering chamber 6, and thus, that the moving particles diffract the light.

The light source 31 may be a laser diode, whose power may be typically around ten or twenty milliwatts, which does not present a major risk when unexpectedly and indirectly observing the beam with the eyes. The beam is of oblong shape with two Gaussian distributions at 90° from each other. It is also possible to consider that it is almost of rectangular shape, with a diameter of 3.5×1.5 millimeters. Thus, the beam crosses the scattering chamber 6 with the largest side of the beam vertical, i.e., parallel to the chamber, thus providing the longest possible transit time for the particles in the beam. The chamber being cylindrical, with a diameter of 22 millimeters, the volume of the beam in the chamber is of 0.1155 cubic centimeters. This light source 31 emits a light beam 30 in a given direction 31.

The diaphragm 32 is placed in front of the light source 31 such that it only selects a portion of the light field 30 generated by this source. For example the shiniest or the most homogenous portion of the light beam 30 may be chosen.

The main detection means 5 comprises a photodetector 52 and a counter 53. This detection means 5 is arranged such as to be oriented in a direction 51 forming an angle α, equal to 15°, with respect to the direction 31 of the light field 30 generated by the light source 31. The justification of this angle is that at small scattering angles, the effect of the absorbing power of the particles has little influence. Beyond 30°, the absorbing effect becomes significant and the diffused flux drops considerably. Thus, carrying out measurements for a scattering angle between 10° and 20° has several advantages. The diffused flux is at its maximum. Considering that for a dimension higher than 1 micrometer, the liquid droplets represent only a very small quantity, the diffused flux comes exclusively from the solid particles. At higher angles, the flux diffused by the absorbing solid particles becomes very low and in certain instances, may be confounded with the flux diffused by the residual liquid particles of large dimensions.

The photodetector 52 is a photodiode, thus, preferably the collector area is the largest possible in order to observe the totality of the light flux in the scattering chamber. A photodiode collector area may be typically of 3.6 square millimeters. This photodetector makes it possible to convert the light flux received into an electric signal.

The counter 53 embodies a detector of electric pulses converted by the photodiode 52 from the diffused flux received.

With respect to an angle lower than 30°, and more particularly for an angle of 15°, the counting technique makes it possible to obtain the concentration of solid particles with a diameter of about 1 to 10 micrometers with a good precision. Moreover, the intensity of the flux diffused at this angle makes it possible to statistically provide a qualitative assessment of the diameter of the detected particles. Thus, it is possible to provide the concentration of particles for example in 3 size ranges: less than 1 micrometer, between 1 and 2.5 micrometers and between 2.5 and 10 micrometers. The instrument calibration (values of the measured fluxes depending on the particle size) is carried out by using particles of different natures, from the lightest to the darkest possible. Thus, no use of a theoretical model for computing light scattering (such as “Mie scattering”) is necessary.

The counter 53 must process the received signal to filter it and to distinguish the electric pulses which correspond to a particle diffused from a signal arising from a spurious light. This element must take into account the order of magnitude of the light flux received by the detector.

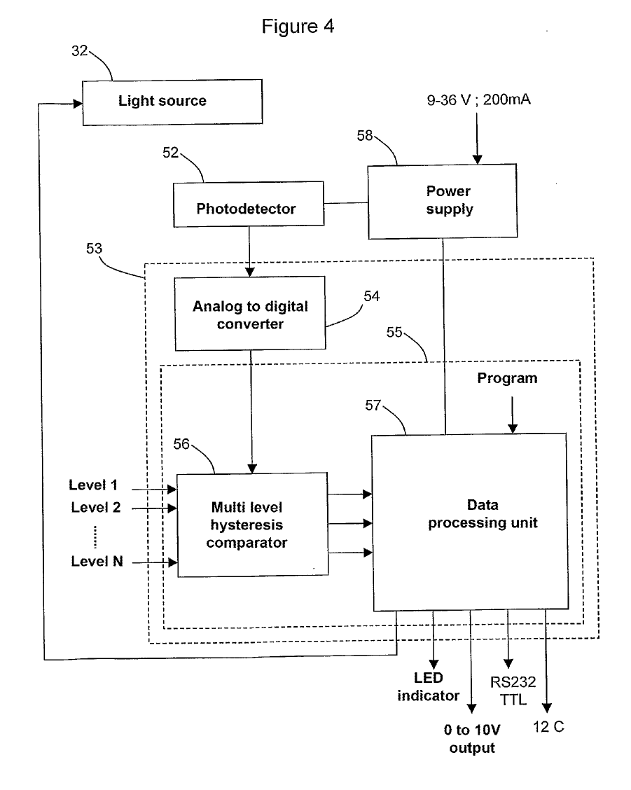

To this end, the counter 53 comprises an analog-digital conversion block 54 and a signal processing block 55. The flow rate being of 1 cubic meter per hour, the transit time of an aerosol in the laser beam of a thickness of 3.5 mm is about 5 meters per second. Therefore, the analog-digital conversion block 54 operates at a frequency of at least 10 kHz in order to have a sufficient sampling to observe the pulse width when the particle crosses the beam. Thus, several dozen points that will make it possible to characterize the length and intensity of the pulse. The signal processing block 55 will be described further down with reference to FIG. 4.

The skilled person will notice that no lens, or, more generally, no means for collecting and focusing the light, is integrated to the analyzing system 1, making the integration of the system easier and highly reducing its production costs. The skilled person will clearly appreciate that the absence of lens also makes it possible to decrease the spurious light, as well as to avoid possible optical malfunctioning problems, particularly during temperature variations of the ambient medium or handling of the instrument. This absence also makes it possible to reduce the field of view only at an angular width of a few degrees, thus making it possible to improve the comparison of measurement values with those determined theoretically or from a database.

The skilled person will also note that the light beam flow rate, cross-section and chamber size values are given here by way of example. The instrument can operate with lower or higher flow rates, thus simply requiring an adjustment of the dimensions of the light source beam and an optimization of the detection speed.

The light trapping means 4 comprises an optical gun 41 and a light trap 42. It makes it possible to trap non diffused light, that is to say, whose trajectory is not disrupted by the particles crossings the beam so that it is not collected by a detector and does not come to disrupt the result.

The optical gun 41 makes it possible to minimize the spurious light reflections along the light beam travel.

The light trap 42 makes it possible to avoid spurious light reflections by the beam at the end of its travel.

A second optical gun 43 makes it possible to adjust the field of view of the detector at the dimension of the optical chamber and to limit the observed scattering angle range.

In another embodiment of the invention, the optical gun 41 is replaced by an optical fiber with a lens. However, the optical gun is preferred as far as the optical fiber requires more precise adjustments and leads to a sizeable flux loss.

The scattering chamber 6 has the shape of a cylindrical tube in which the particles are caused to move when crossing the tube. This chamber is surrounded by a darkroom making it possible to prevent spurious reflections on the tube walls which could interfere with the measurement results.

A pump-type suction device (not shown) allows the driving of the particles inside the tube of the chamber 6. The air flow rate is typically of about 1 cubic meter per hour.

An impactor type dimensional selection device (not shown) located upstream from the scattering chamber makes it possible to let only the particles exhibiting a certain diameter range, for example a diameter lower than 10 micrometers to pass.

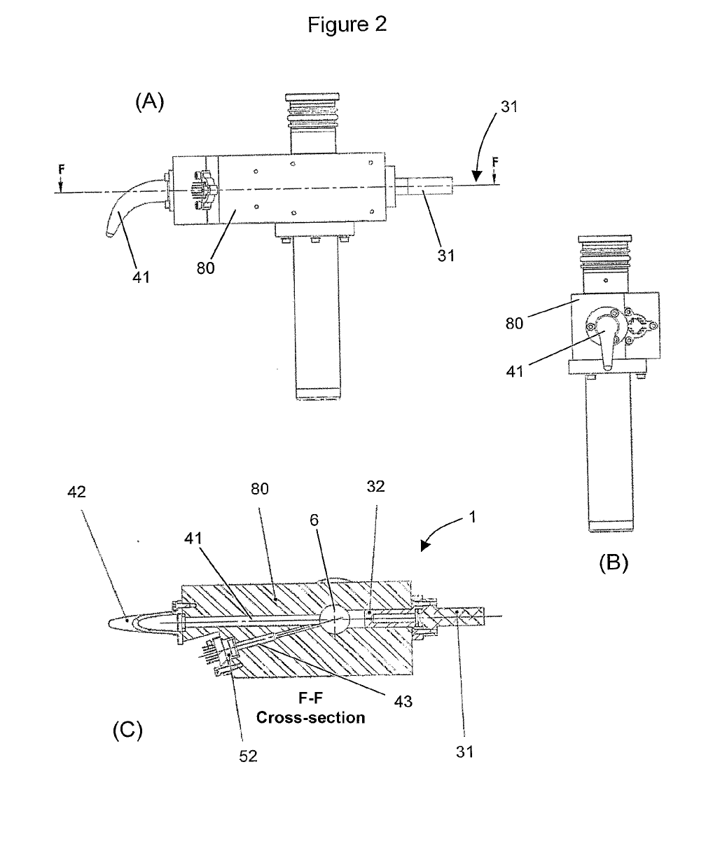

FIGS. 2A to 2C represent views of an implementation of an analyzing system according to the previously described embodiment. FIGS. 2A and 2B particularly represent profile views of the system, whereas FIG. 2C represents a cross-sectional top view of this system.

The analyzing system 1 is in the shape of an optical module which can be integrated or connected to other modules, in particular, electronic modules or display modules. The scattering chamber 6, which serves as a solid particle collection tube, is surrounded by a dark room 80 which makes it possible to isolate it and thus, protect it from the effects of spurious lights.

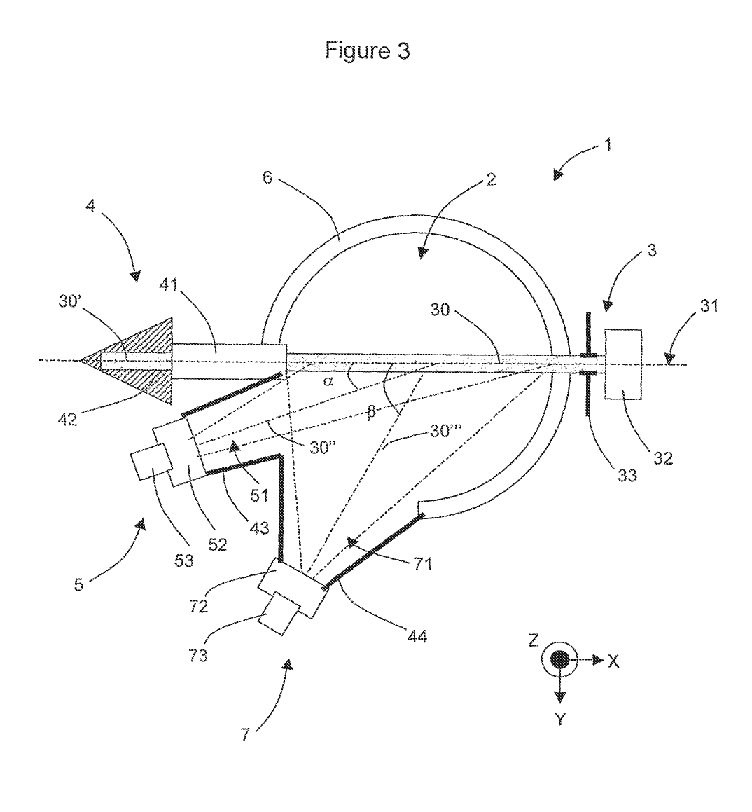

A second embodiment of the system for analyzing solid particles is now described with reference to FIG. 3.

The elements of this analyzing system are similar to those of the analyzing system according to the first embodiment previously described with reference to FIGS. 1 and 2. It also comprises a complementary detection means 7 analogous to the main means 5, but oriented in a direction 71 forming an angle β, substantially equal to 60°, with respect to the direction 31 of the light field 30. This complementary means 7 comprises a detector 72 and a counter 73 similar to those of main means 5. A third optical gun 44 makes it possible to adjust the field of view of the detector to the dimension of the optical chamber and limit the observed scattering angle range.

A simultaneous measurement for a scattering angle of 60°, where the effect of the absorption is the most obvious, makes it possible to assess the absorption power and the nature of the diffusing particles accordingly. This angle actually corresponds to the area where the most absorbent particles diffuse the least light.

For this, an analysis of the acquired data (levels of scattered signals at the different angles) has been carried out, not from theoretical computation of light diffusion but from a database obtained beforehand in a laboratory with this instrument. This database is open and may be completed depending on new needs identified by the users.

The skilled person will note that for particles that are very absorbent, the diffused flux is almost the same for angles beyond 60°, whereas it continues to decrease for less absorbent particles and it can go beyond 140°. Moreover, the decrease of the diffused flux is stronger between 0° and 60° for absorbent and dark particles than for light and/or transparent particles. In these conditions, it is possible to define the ratio of the intensities of the diffused fluxes around 15° and from 60°, this ratio becoming greater the more absorbent the considered material is, and smaller the more transparent the material is.

Thus, by combining the measurements around 15° and 60°, it is possible to provide an assessment of the nature of the particles dominating the medium under examination. This analysis is performed by carrying out the ratio of the signals measured on the two paths during a few seconds and by comparing the results with reference measurements obtained in laboratories for particle families: carbonaceous compounds, soot, sand, silica, white silicates, industrial ashes, etc. This comparison approach compared to a database makes it possible to avoid the use of light diffusion models giving only very imperfect results in the case of irregular particles.

Other complementary detection means may be used at other scattering angles, which makes it possible to provide complementary information. However, the number of these detection means remains limited by their encumbrance.

The counter 53 of the analyzing system 1 is now more particularly described according to a particular embodiment of the invention with reference to FIG. 4.

The counter 53 comprises an analog-digital conversion block 54 and a signal processing block 55. The role of this counter 53 is particularly to ensure that the detection from the pulse detector is real, as well as to learn the level of spurious light. It makes it possible to minimize certain influencing factors, such as electronic noise, humidity, the time drift, etc.

For a beam of a cross-section of 0.3 square centimeters, with a flow rate of 1 cubic meter per hour and a concentration of 1 particle per cubic centimeter, up to a few particles per second should be detected. The conversion block 54 must thus carry out a sampling of at least 20 kHz to properly separate the contribution of each particle which is present in the signal in the form of a peak.

For example 10 measurement seconds may be registered then, in the signals of a photodiode—or of several in the case of a multi-detection system—all present peaks may be simultaneously searched. Each relative maximum corresponds to the detection of a particle. Depending on the signal level, whether a large particle (strong signal), a medium-sized particle or a small particle (signal close to the detection limit and the background noise caused by the liquid aerosols) is present may be estimated.

The role of the photodiode 52 at a scattering angle of 15° is to assess the particle concentration. The role of the photodiode 72 at 60° is to assess the nature of the particles. Thus, in the case of the two detectors, it is necessary to divide point by point both measurement lines. Then, at each position of the peaks, the value of the ratio between the measured intensities at 15° and 60° should be identified. This ratio varies from one peak to another if the nature of the particles change. It is necessary that measurements in a laboratory with particles that have known optical properties be carried out beforehand so as to empirically establish values of this ratio.

As illustrated in FIG. 4, the signal processing block 55 comprises a multi-level Hysteresis comparator 56 and a processing unit 57. The photodetector 52 and the processing unit 57 receive power from a power supply 58.

In an advantageous embodiment of this block 55, it also comprises means for eliminating the contribution of the residual spurious light, which can change from one instrument to the next, but also evolve over time. Thanks to these means, the detector background noise is decreased, substantially improving the immunity to the noise of the detector/comparator system. Thus, a detection of particles with greater sensitivity than without a filter is possible.

The N-level Hysteresis comparator 56 makes it possible to distinguish several particle sizes based on the amplitude of the desired signal from the photodetector. The Hysteresis function of the comparator 56 makes it possible to avoid the brutal changes of the logical states at the output of the comparator when the shape progression of the desired signal is not continuous.

The processing unit 57 for processing the different detection levels makes it possible to count the number of particles according to their dimensional classification, to validate the measurements by monitoring the values of the photodetector supply voltages, the detector output voltage level and the laser supply current and makes it possible to obtain measurement results during continuous sampling periods.

At this processing unit 57, an extraction of the significant signal, which may be combined to the spurious light, is also carried out. In fact, at the small scattering angles, the contribution of the spurious light may become majority. The signal diffused by the particles is added to the spurious light. From then on, in order to detect the smallest particles and assess the size of the larger ones, the significant signal needs to be extracted.

To this end, the following procedure may be carried out to assess in nearly real time the spurious light and obtain the desired real signal:
before a light diffusion peak, the continuous signal component representing the spurious light is determined over a time interval the length of which is equal to or higher than that of a diffusion peak,
this continuous component is substracted by filtering from the total registered signal at the diffusion peak (only the signal diffused by the particle remains), and
the search for the continuous component is carried out regularly in order to adapt to a possible temporal drift of the spurious light.

In this manner, no re-calibration of the instrument is necessary. Moreover, this procedure makes it possible to extract a significant signal which may be of about 0.1% or more of the total signal (the spurious light thus being able to represent up to 99.9% of the signal.)

In another embodiment of the invention, it is also possible to consider the form of the registered signal. Due to the travel time of the particles in the beam having a certain thickness, the signal must be in the form of a peak of a certain width linked to the speed of the particles. Henceforth, any signal of a duration much lower than this time may be considered as noise. The electronic shifting and the contribution of the spurious light may be computed between two clearly separated peaks.

In another alternative of the invention, the detection means are combined with a means for polarimetrically analyzing the diffused light field. A polarizing system, requiring the use of two detectors per diffusion angle where the measurement are carried out may be used. It is possible to reconstruct the polarimetric light diffusion curves for the particles in the field of view. These measurements, compared to a database obtained beforehand in a laboratory, make it possible to access the size distribution of the particles and to assess their nature.

The previously described embodiments of the present invention are given by way of non limitative examples. It should be understood that a man skilled in the art is able to carry out different alternatives of the invention within the scope of the patent.

1. A system (1) for analyzing solid particles in a medium (2), including illumination means (3) capable of generating a light field (30) within the medium (2), means (4) for trapping at least a portion (30′) of the light field (30) generated and arranged in the direction (31) of said light field (30), and main detection means (5) for detecting the light field (30″) diffused by said solid particles within said medium (2), characterized in that said main detection means (5) includes a photodetector (52) of the light field (30″) diffused by said solid particles in said medium (2) and a counter (53) for counting said solid particles in said medium (2), said main detection means (5) being oriented in a direction (51) forming an angle (α) substantially ranging between 10° and 20°, with respect to the direction (31) of the light field (30).

2. The analyzing system (1) according to claim 1, wherein the main detection means (5) is oriented in a direction (51) forming an angle (α) substantially equal to 15° with respect to the direction (31) of the light field (30).

3. The analyzing system (1) according to claim 1, also comprising at least a complementary detection means (7) for detecting the light field (30″′) diffused by the solid particles in the medium (2), said complementary detection means (7) comprising a photodetector (72) of the light field (30″′) diffused by said solid particles in said medium (2) and a counter (73) for counting said solid particles within said medium (2).

4. The analyzing system (1) according to claim 3, wherein at least a complementary detection means (7) is oriented in a direction (71) forming an angle (β) substantially ranging between 40° and 140° with respect to the direction (31) of the light field (30).

5. The analyzing system (1) according to claim 4, wherein at least a complementary detection means (7) is preferably oriented in a direction forming an angle (β) substantially equal to 100° with respect to the direction (31) of the light field (30).

6. The analyzing system (1) according to claim 4, wherein at least one complementary detection means (7) is oriented in a direction (71) forming an angle (β) substantially equal to 60° with respect to the direction (31) of the light field (30).

7. The analyzing system (1) according to claim 1, also comprising a complementary detection means for detecting the light field diffused by the solid particles in the medium, said complementary detection means comprising a photodetector of the light field diffused by said solid particles in said medium (2) and a counter for counting said solid particles in said medium (2), and being oriented in a direction forming an angle substantially equal to 160° with respect to the direction (31) of the light field (30).

8. The analyzing system (1) according to claim 1 wherein at least a counter (53) comprises a block (55) for processing the signal generated by the corresponding detection means (5).

9. The analyzing system (1) according to claim 8, wherein a pulse signal generated by the detection means (5) is dismissed by the corresponding signal processing block (55) if its duration does not exceed a threshold value depending on the speed of the solid particles in the medium (2).

10. The analyzing system (1) according to claim 1 also comprising a polarimetric means for analyzing the diffused light field.

11. The analyzing system (1) according to claim 1 wherein the illumination means (3) comprises a light source (31) composed of a laser diode.

12. The analyzing system (1) according to claim 1 wherein the illumination means (3) comprises a diaphragm (32) for selecting a portion of the generated light field (30).

13. The analyzing system (1) according to claim 1 wherein the trapping means (4) comprises an optical gun (41) and a light trap (42).

14. The analyzing system (1) according to claim 1 comprising a scattering chamber (6) comprising a sample of solid particles and arranged so as to intercept at least a portion of the light field (30) generated by the illumination means (3).

15. The analyzing system (1) according to claim 14, also comprising solid particle sample driving means capable of driving said sample along the scattering chamber (6) at a predetermined speed.

16. The analyzing system (1) according to claim 14, also comprising solid particle filtering means arranged at the entry of the scattering chamber (6) so as to select said solid particles depending on their dimensions.

17. The analyzing system (1) according to claim 1 having no means for collecting and focusing the light diffused by the particles.

18. A method for analyzing solid particles in a medium (2), comprising an illumination step of generating a light field (30) within the medium (2), a step of trapping at least a portion (30′) of the light field (30) generated and arranged in the direction (31) of said light beam (30) and a step of detecting the light field (30″) diffused by said solid particles in said medium (2), characterized in that the step of detecting said diffused light field (30″) is a step of carrying out a photodetection of the light field (30″) diffused by said solid particles within said medium (2) and of counting said solid particles within said medium (2), said detection step being carried out in a direction (51) forming an angle (α) substantially ranging between 10° and 20° with respect to the direction (31) of said generated light field (30).

19. The analyzing system (1) according to claim 5, wherein at least one complementary detection means (7) is oriented in a direction (71) forming an angle (β) substantially equal to 60° with respect to the direction (31) of the light field (30).

20. The analyzing system (1) according to claim 15, also comprising solid particle filtering means arranged at the entry of the scattering chamber (6) so as to select said solid particles depending on their dimensions.
